(19) United States
(12) Patent Application Publication
(10) Pub. No.: US 2010/0059947 A1
(43) Pub. Date: Mar. 11, 2010

(54) Combination Cart and Safety Ladder

(76) Inventor: Terry Shaw, Central City, NE (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/554,331

(22) Filed: Sep. 4, 2009

Related U.S. Application Data
(60) Provisional application No. 61/094,451, filed on Sep. 5, 2008.

(51) Int. Cl. B62B 3/14; F16B 1/00; E06C 5/32

(52) U.S. Cl. 280/33.992; 403/326; 182/129

(57) ABSTRACT

A combination cart and safety ladder assembly for storing items selected for purchase and retrieving items from otherwise unreachable store shelves. The combination has a base, a plurality of wheels joined with the base, a cart section, and a ladder section having a plurality of steps. Preferably, the ladder section is moveable between a first position in which the ladder section prevents the wheels from transporting the base and a second position in which the wheels are free to transport the base. Most preferably, a resilient member biases the ladder section to its second position such that the wheels are free to transport the base unless the biasing force is overcome. When a user mounts the steps, the biasing force of the resilient member is overcome thereby moving the ladder section into its first position for preventing movement of the base and safely allowing the user to retrieve an item.

### CROSS-REFERENCE TO RELATED APPLICATIONS

This application is based on and claims priority to U.S. Provisional Application Ser. No. 61/094,451, filed on Sep. 5, 2008 which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention is related to a cart, and more particularly, to a combination cart and ladder for safely retrieving items from hard to reach upper store shelves.

2. Description of Related Art

Many people cannot reach items located on high shelves, such as the top shelves in supermarkets. Although there are many different types of people that may have difficulty reaching items on high shelves, some examples include persons having a physical ailment that restricts mobility, such as arthritis, and little persons. Typically, if a person cannot reach an item on a high shelf, he or she must either ask another person, such as a store employee or another shopper, to retrieve the item for them or attempt to retrieve the item on their own. Typical methods for retrieving an unreachable item include unlodging the item from the shelf with a pole or grabbing device and then attempting to catch the item as it falls from the shelf to the floor. This method is undesirable because it can be dangerous to retrieve heavy items using the method and if the item is not caught, the item may be damaged and/or create a mess requiring clean-up, especially if the item contains liquid.

Another method for retrieving otherwise unretrievable items from a store shelf includes using a large moveable safety ladder such as those typically used by store personnel to stock upper store shelves. These safety ladders are typically very large and difficult to maneuver in stores having narrow aisles, which is typical of many grocery stores. Many stores do not have a safety ladder and even if a store does, the ladder is typically stored in a location away from the aisles so that it does not cause an obstruction for shoppers. Thus, in order for a person to use such a ladder, they must first roam the store in an attempt to locate one. Also, once the ladder is taken from its stored location and moved to where it is needed, cumbersome wheel locking mechanisms that make the ladder stable and safe to climb upon are often difficult to engage and disengage. Thus, a need remains for a convenient device that assists shoppers in reaching upper store shelves.

### BRIEF SUMMARY OF THE INVENTION

The present invention provides a solution to the problems identified above. The present invention is a maneuverable, lightweight, and easy to use assembly that combines a cart with a ladder to provide a store customer with access to items on shelves that the customer cannot reach. The assembly also has a conventional shopping cart container or basket to carry items selected from the store shelves for purchase.

In accordance with one embodiment of a combination cart and ladder according to the present invention, the combination has a base that is coupled with a plurality of wheels for transporting the base across a surface. A cart section is coupled with the base, and preferably includes some type of container for storing items selected by a customer for purchase. A ladder section is also coupled with the base and includes a plurality of steps, which preferably may be used to retrieve items from store shelves that are otherwise unreachable.

Preferably, the ladder section of the combination cart and ladder is moveable between a first position in which the ladder section prevents the wheels from transporting the base, and a second position in which the wheels are free to transport the base. With the ladder section in its first position, it is safe for a user to ascend and descend the steps without movement of the combination cart and ladder. A resilient member preferably couples the ladder section and the base to bias the ladder section to its second position so that a customer is free to move the cart and ladder around a store unless the biasing force is overcome. In a most preferred embodiment, the resilient member comprises a coil spring positioned between a portion of the ladder section and a portion of the base; however, it is within the scope of the invention for the ladder section to be biased to its second position by other methods or structures. In the coil spring embodiment, when a user first exerts a downward pressure or force on one of the steps, that force overcomes the biasing force of the coil spring thereby moving the ladder section from its second position to its first position, in which the combination cart and ladder is no longer moveable.

In a most preferred embodiment, the cart and ladder combination comprises a base having front, middle, and rear pairs of wheels. A basket type container, typical of a conventional shopping cart, is supported by a frame joined with and extending upward from a rear portion of the base. A ladder section has a frame that is joined with and extends upward from a front portion of the base for supporting steps to assist a customer in reaching otherwise unreachable items from store shelves. The frame is pivotally joined with the base such that the frame and steps are moveable between first and second positions as described above. There is a resilient member coupling the frame and base in a location spaced a distance from where the frame is pivotally joined with the base for biasing the frame to its upward position. When a customer exerts a force on the steps sufficient to overcome the biasing force, the frame and steps move into their down position, in which the frame contacts a floor surface for preventing movement of the cart and ladder combination. When the customer eventually departs from the steps, the biasing force of the resilient member forces the steps and frame back to its upward position, in which the cart and ladder combination is freely moveable. In contrast to the conventional methods for retrieving otherwise unreachable items, the combination cart and ladder of the present invention is convenient and safe.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of the preferred embodiment of the combination cart and ladder according to the present invention;

FIG. 2 is a side elevational view of the combination cart and ladder of FIG. 1:

FIG. 3 is a top plan view of the combination cart and ladder of FIG. 1;

FIG. 4 is a side elevational view of a portion of the combination cart and ladder of FIG. 1 showing a spring housing in cross-section; and

FIG. 5 is a perspective view of a ladder section of the combination cart and ladder of FIG. 1.

### DETAILED DESCRIPTION OF PREFERRED EMBODIMENT

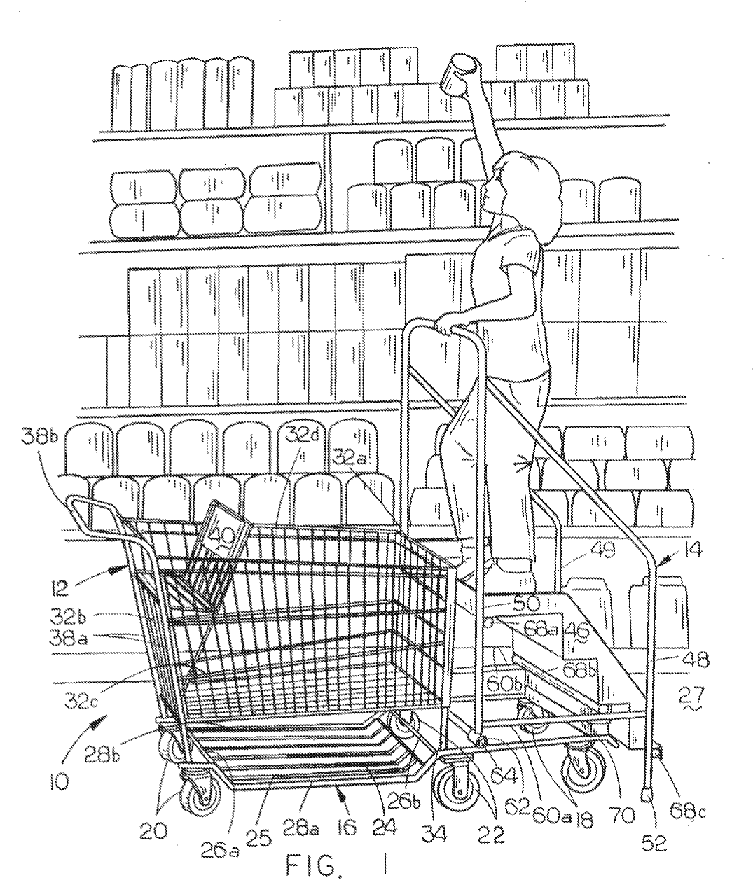

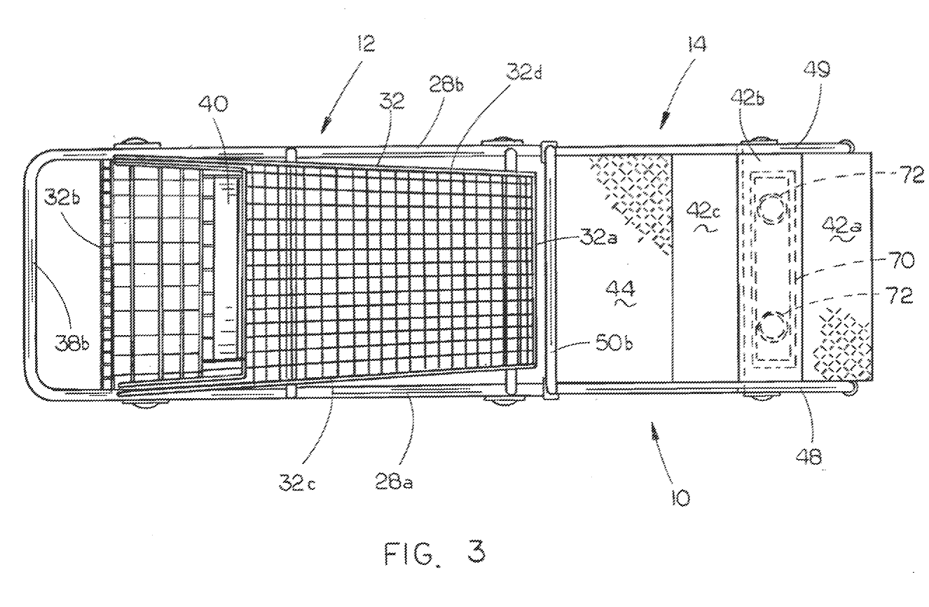

A combination cart/ladder assembly according to a preferred embodiment of the present invention is shown generally as 10 in FIGS. 1-5. While the embodiment shown in FIGS. 1-5 is described in detail below, the invention is not limited to this specific construction or configuration. Rather, the present invention encompasses a variety of configurations and embodiments.

Referring to FIGS. 1-5, the combination cart/safety ladder assembly 10 comprises a cart section 12 and a ladder section 14 that share a common base section 16. The cart section 12 is positioned rearward of the ladder section 14. The cart and ladder sections 12 and 14 have approximately the same width for maneuverability within a store.

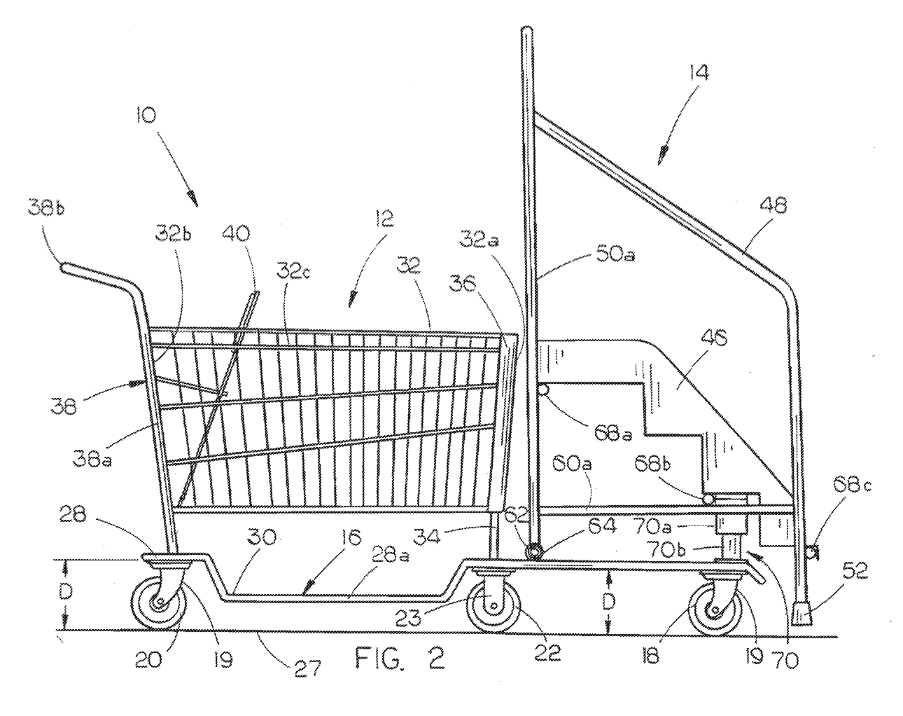

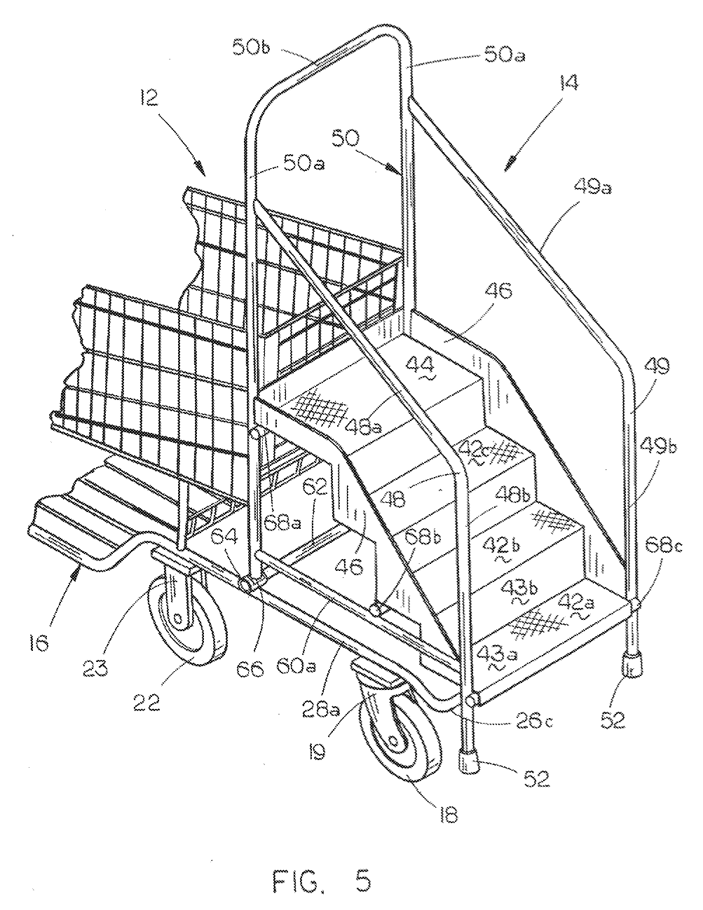

As shown in FIGS. 1 and 2, the base section 16 is a substantially rectangular shaped frame having a pair of longitudinal lengths 28a and 28b and transverse lengths 26a, 26b, and 26c (FIG. 5) that support the cart section 12 and the ladder section 14. The frame is preferably constructed of metal, but other rigid materials such as hard plastic may be used. Although the base section 16 is shown as a frame comprising a plurality of joined tubes or lengths, it is within the scope of the invention for the base to be formed from any material and for the base to have any shape sufficient to support the cart section 12 and the ladder section 14.

The base section 16 has two forward wheels 18, two rearward wheels 20, and two middle wheels 22 positioned between the forward wheels and the rearward wheels. The forward and rearward wheels 18 and 20 are affixed to the corners of the rectangular frame of the base section 16. Preferably, the forward and rearward wheels 18 and 20 are of the swivel caster type to allow easy steerage of the assembly 10. As shown in FIG. 2, each forward and rearward wheel 18 and 20 is joined to the base section 16 with a bracket 19. The brackets 19 are joined to the base section 16 with a swivel mount to enable a user to turn the assembly 10. Further, the brackets 19 are shaped so that an imaginary line passing through the location where the wheels 18 and 20 are joined to the brackets 19 and the location where the brackets 19 are joined to the base section 16 is angled with respect to an imaginary vertical line. This angle, which is typically referred to as a caster angle, enables an operator of the assembly 10 to easily steer the assembly. The middle wheels 22 are preferably joined to the base section 16 with a bracket 23 that is fixedly mounted to the base section such that the wheels cannot swivel. Although the preferred embodiment shows forward and rearward wheels 18 and 20 that are joined to the base section 16 with swivel mounted brackets 19 and middle wheels 22 that are joined to the base section 16 with fixed brackets 23, it is within the scope of the present invention to use any type or number of wheel or wheel mount to support and maneuver the assembly. Preferably, the wheels 18, 20, and 22 are made of rubber; however, it is within the scope of the invention for the wheels to be made from any other type of material.

Referring to FIGS. 1 and 2, the longitudinal lengths 28a and 28b between the middle wheels 22 and rearward wheels 20 are adapted to provide a carrying platform 24 formed from a series of spaced apart rods, one of which is shown as 25, extending from transverse support rod 26b. As shown in FIGS. 1 and 2, longitudinal lengths 28a and 28b are configured with a dip section 30 while the distance between the floor 27 and the base section 16 at each of the wheel mounting locations is a consistent distance D. The forward end of each longitudinal length 28a and 28b is angled slightly downward adjacent where the lengths are joined with transverse length 26c. The dip section 30 and the specific configuration of the lengths 28a and 28b described herein and shown in the drawings is not essential to the present invention.

Referring to FIGS. 1-3, the cart section 12 comprises a mesh basket 32 that is generally box shaped with a forward end 32a, a rearward end 32b, and opposing sides 32c and 32d. The forward end 32a of the basket is affixed to the base section 16 by support posts 34. Reinforcing strips 36, shown in FIG. 2, are affixed to the vertical edge of the basket 32 at its forward end 32a. The rearward end 32b of the basket is affixed to the base 16 with an inverted U-shaped post 38 having two legs 38a and a horizontal handle section 38b. The horizontal handle section 38b extends a distance above the upper edge of the basket 32 and is angled outward from the basket to facilitate its use by a shopper. Adjacent the rearward end 32b is a seat structure 40 that is configured to pivot between a collapsed position and an expanded position, which is shown in FIGS. 1-3. Although preferably the cart section 12 is as shown in the drawings and described herein, it is within the scope of the invention for the cart section to have any structure sufficient for storing items and for the cart section to be mounted to the base 16 by any method.

Referring now to FIGS. 1-5, the ladder section 14 of the preferred embodiment is positioned forward of the cart section 12 and includes a plurality of steps or stairs 42a, 42b, and 42c and an upper platform 44. Step 42a is the lowest step, while steps 42b and 42c are middle steps positioned in between the lower step 42a and the upper platform 44. Preferably, the ladder section 14 comprises three steps 42a, 42b, and 42c, each of which includes a tread section and a riser section, and a substantially rectangular shaped horizontal platform 44. The tread section of step 42a is labeled as 43a in FIG. 5 and the riser section of the step is labeled as 43b. As shown in FIG. 5, the steps are positioned between a pair of elongated parallel spaced apart sidewalls 46. The sidewalls 46 are mounted to the transverse side edge of each step 42a, 42b, and 42c and extend vertically upward above the tread section of each step. The sidewalls 46 also extend upward around three edges of the platform 44 for providing a safe surface on which to stand. The steps 42a, 42b, and 42c and platform 44 are preferably attached to the sidewalls 46 using any conventional mounting method such as screws, rivets, or welding. Although the steps are preferably configured as described above, it is within the scope of the invention for there to be any number of steps having any configuration that permits a shopper to access hard to reach shelves.

The ladder section 14 has a frame which includes a pair of handrails 48 and 49, and an inverted U-shaped mounting post 50. The U-shaped mounting post 50 preferably has two vertical portions 50a that are joined with a horizontal portion 50b, which forms the top of the mounting post. Each handrail has an angled portion 48a, 49a that generally rises with the same slope as the steps 42a, 42b, and 42c, and a vertical portion 48b, 49b. The upper end of each handrail 48, 49 is joined with the U-shaped mounting post 50. The lower end of each handrail 48, 49 has a leg portion with an anti-skid base cap 52. It should be noted that other configurations of the handrail leg portion 48, 49 and base cap 52 are within the scope of the present invention and that preferably there is an anti-skid structure provided at the lower end of the handrail 48, 49. The base cap 52 however is not required for the operation of the present invention. As shown in FIG. 5, the frame of the ladder section 14 also has a lower support rail 60a that is joined with the vertical portion 48b of the handrail and the U-shaped mounting post 50. There is also another lower support rail 60b, shown in FIG. 1, that is joined with the vertical portion of the handrail 49b on the opposite side of the ladder section and the U-shaped mounting post 50. A transverse support member or rail 62 is joined with the lower ends of each vertical portion 50a of the U-shaped mounting post 50.

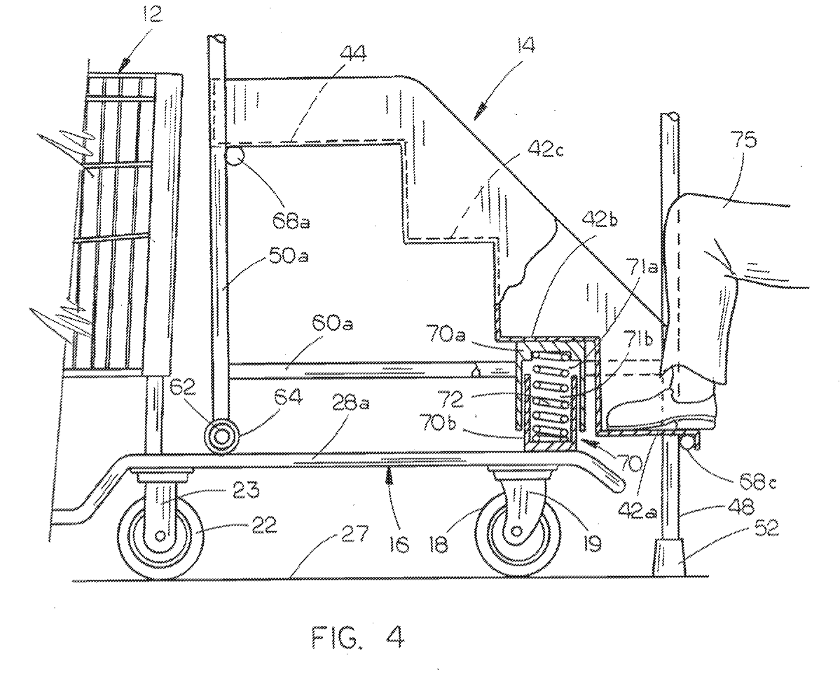

As shown in FIGS. 4 and 5, a journal sleeve 64 is mounted to longitudinal length 28a for receiving an end of transverse support member 62. There is another journal sleeve (not shown) that is mounted to longitudinal length 28b for receiving the opposite end of support member 62. The transverse support member 62 can rotate within the journal sleeve 64 on each of longitudinal lengths 28a and 28b. Sleeve 64 has a slot 66 along its circumference that receives the lower end of the U-shaped mounting post 50a and allows it to move with rotation of the support member 62 that the mounting post 50 is joined with. Preferably, the slot 66 allows the vertical portion 50a of the U-shaped mounting post 50 to move from an angled position as shown in FIG. 2 to a substantially vertical position. Although the journal sleeve 64 with slot 66 is preferable to allow the vertical portion of U-shaped mounting post 50a to travel, it is within the scope of the present invention to utilize sleeve 64 without slot 66. It should also be noted that any configuration that allows the lower end of the U-shaped mounting post 50a to pivot with respect to the base section 16 is also within the scope of the present invention.

Referring to FIGS. 2 and 5, the ladder section's 14 frame also includes a transverse support member or rail 68a that is joined with and extends between the mid-section of each vertical portion 50a of the U-shaped mounting post 50. The transverse support member 68a is also joined with and supports the upper platform 44. A transverse support member or rail 68b is joined with and extends between the lower support rails 60a and 60b. The transverse support member 68b is joined with and supports the underside of middle step 42b. Another transverse support member or rail 68c is joined with and extends between the vertical portions 48b, 49b of each handrail 48, 49. The transverse support member 68c is also joined with and supports lower step 42a. Although the ladder section 14 frame components and steps 42a, 42b, and 42c preferably have the construction described above, different configurations are within the scope of the present invention.

Referring now to FIGS. 2-4, in a preferred embodiment, the cart/ladder assembly 10 has a coil spring assembly 70 comprising an upper housing 70a, a lower housing 70b, and at least one coil spring 72 positioned between the upper and lower housings. The upper housing 70a is attached to the under side of the middle step 42b and the lower housing 70b is attached to the base section 16 in spaced relation below the upper housing 70a. As shown in FIG. 4, the upper housing 70a has a top wall joined to the step 42b and opposing side walls to define an interior cavity 71a. The lower housing 70b has a bottom wall joined to the base 16 and opposing side walls to define an interior cavity 71b. The side walls of the lower housing 70b are received within the cavity 71a of the upper housing 70a thereby permitting the housings 70a and 70b to move relative to each other with compression and extension of the coil spring 72 positioned within the cavities 71a and 71b. The coil spring assembly 70 is preferably adapted to be mounted in the uncompressed state and moves to a compressed state when a substantially downward axial force is applied to it such as when a shopper mounts and ascends the steps. Although a coil spring 72 is preferably used in the coil spring assembly 70, it is within the scope of the invention to use any other type of resilient member or suspension device such as a leaf spring, piston, shock absorber, or tension spring. It should be noted that other configurations of the coil spring assembly 70, including the upper and lower housings 70a, 70b and their respective mounting positions, may be utilized and are within the scope of the present invention. Further, it is within the scope of the present invention to utilize any type of resilient member to bias the steps to the upward position shown in FIG. 2 when no downward force is applied to the steps.

As shown in FIGS. 2 and 4, handrails 48, 49 and steps 42a, 42b, and 42c have two positions, the first or up position shown in FIG. 2 and the second or down, position shown in FIG. 4. Referring to FIG. 2, in the up position, the coil springs 72 within the coil spring assembly 70 are in an uncompressed state and exert an upward force on step 42b. This upward force biases the steps 42a, 42b, and 42c and the handrails 48, 49 into their first or up position. Unless a downward force is exerted on the steps 42a, 42b, and 42c to overcome this biasing force provided by the coil spring assembly 70, the steps and handrails will remain in the up position. When the steps 42a, 42b, and 42c and handrails 48, 49 are in their up position, the anti-skid base caps 52 oil the end of the handrails are not in contact with the floor, thus allowing the wheels 18, 20, and 22 of the assembly 10 to freely move the base 16 over the floor surface 27.

Referring to FIG. 4, when a downward force is exerted on step 42a by a leg 75 of a user, the steps 42a, 42b, and 42c and handrails 48, 49 move to their down position in which the coil springs 72 within the coil spring assembly 70 are compressed. In moving from the up position shown in FIG. 2 to the down position shown in FIG. 4, the steps 42a, 42b, 42c, handrails 48, 49, U-shaped mounting post 50, and ladder section frame components 60a, 60b, 62, 68a, 68b, and 68c rotate about their pivot point at journal sleeve 64. This rotation causes the upper housing 70a of the coil spring assembly 70 to move downward relative to the lower housing 70b thereby compressing the coil springs 72 positioned within the assembly. When the handrails 48, 49 are in their down position, the anti-skid base caps 52 on the lower ends of handrails 48, 49 contact the floor surface 27 to prevent the wheels 18, 20, and 22 from transporting the base 16 across the floor 27. Thus, when a user steps on the ladder section 14, the anti-skid base caps 52 ensure that the assembly 10 will not move and pose a threat to the safety of the user while the user is on the ladder section 14. When the user steps off of the ladder section 14, the coil springs 72 exert an upward biasing force on upper housing 70a and step 42b to move the handrails 48, 49 and steps 42a, 42b, and 42c back to their up position, shown in FIG. 2, so that the assembly 10 may be moved to another location.

In operation, a user of the cart/ladder assembly 10 pushes the horizontal handle section 38b until the cart/ladder assembly is in a desired position. If the user needs assistance in retrieving an item from an upper store shelf that the user cannot reach, the user moves from the rear of the cart/ladder assembly 10 around to the front of the assembly adjacent ladder section 14. The user then steps on and exerts a downward pressure or force on the lowest step 42a. This force is transferred to the coil springs 72 thereby causing partial compression of the coil springs 72. With the coil springs 72 compressed, transverse support member 62 pivots about journal sleeve 64 thereby lowering the vertical portions of the handrails 48b, 49b until base caps 52 contact the floor surface 27. When the handrails 48, 49 and steps 42a, 42b, and 42c are in this down position, the user can safely ascend the steps to retrieve the previously unreachable item, as shown in FIG. 1, and descend the steps 42 without movement of the assembly 10. When the user is positioned on the upper platform 44, the horizontal portion 50b of the U-shaped mounting post 50 provides a handle for the user to hold on to while on the platform 44. Once the user has descended the steps 42 and is no longer on the ladder section 14, there is no longer any downward pressure or force exerted on the steps 42a, 42b, and 42c, and thus the pressure on the coil spring 72 is released. This in turn causes the handrails 48, 49, steps 42a, 42b, and 42c, and support member 62 to pivot about journal sleeve 64 back to their up position, as shown in FIG. 2. In this up position, the anti-skid base caps 52 are no longer in contact with the floor surface 27 and thus the wheels 18, 20, and 22 of the assembly 10 are free to transport the assembly 10 around the store.

Thus, from the above description and drawings it can be seen that the cart/ladder combination of the present invention is a safe and convenient device for both storing and transporting items and retrieving items from hard to reach upper store shelves.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A combination cart and ladder that is configured to be transported across a surface, comprising:
a base;
a plurality of wheels coupled with said base for transporting said base across the surface;
a cart section coupled with said base; and
a ladder section coupled with said base, said ladder section comprising a plurality of steps.

2. The combination of claim 1, wherein said ladder section is moveable between a first position in which said ladder section prevents said wheels from transporting said base, and a second position in which said wheels are free to transport said base.

3. The combination of claim 2, further comprising a resilient member coupling said ladder section and said base, said resilient member biasing said ladder section to its second position.

4. The combination of claim 3, further comprising an upper housing joined to an underside of one of said steps and a lower housing joined to said base beneath said upper housing, said upper and lower housings defining a cavity within which said resilient member is positioned.

5. The combination of claim 3, wherein said resilient member comprises a spring.

6. The combination of claim 3, wherein said ladder section further comprises a frame that supports said steps, said frame pivotally coupled with said base, said resilient member spaced a distance from where said frame is pivotally coupled with said base.

7. The combination of claim 6, wherein said plurality of steps comprises a lower step, an upper platform, and at least one middle step positioned in between said lower step and said upper platform, wherein said frame further comprises:
a first transverse support rail pivotally coupled with said base;
a mounting post coupled with and extending upward from said first transverse support rail;
a pair of handrails each comprising a first end that contacts the surface beneath said wheels when said ladder section is in its first position and a second end that is joined with said mounting post;
a second transverse support rail coupled with said mounting post, said second transverse support rail supporting said upper platform; and
a third transverse support rail coupled with each of said handrails, said third transverse support rail supporting said lower step.

8. The combination of claim 7, wherein said frame further comprises a pair of lower support rails each of which is coupled with said mounting post and one of said handrails, and a fourth transverse support rail coupled with each of said lower support rails, said fourth transverse support rail supporting said at least one middle step.

9. The combination of claim 8, wherein said base comprises a pair of spaced apart longitudinal lengths each of which supports said first transverse support rail, and first, second, and third transverse lengths each of which being joined with each of said longitudinal lengths and extending between said longitudinal lengths, said plurality of wheels comprising a forward pair of wheels generally adjacent said first transverse length, a middle pair of wheels generally adjacent said second transverse length, and a rearward pair of wheels generally adjacent said third transverse length.

10. The combination of claim 9, wherein said cart section comprises a U-shaped post coupled with said base and extending upward from said base, and a container joined with and supported by said U-shaped post, said container having a forward end generally positioned above said middle pair of wheels and a rearward end generally positioned above said rearward pair of wheels, said upper platform of said ladder section positioned generally forward of said forward end of said container, and said lower step of said ladder section positioned generally adjacent said forward pair of wheels.

11. A cart configured to be transported across a surface, comprising:
a base;
a plurality of wheels coupled with said base for transporting said base across the surface;
a container supported by said base; and
a plurality of steps supported by said base, said steps moveable between a first position in which said steps are supported by the surface thereby preventing said wheels from transporting said base and a second position in which said wheels are free to transport said base.

12. The cart of claim 11, further comprising a resilient member coupling said steps and said base, said resilient member biasing said steps to their second position.

13. The cart of claim 12, wherein said steps are pivotally coupled with said base at a location that is spaced apart a distance from said resilient member.

14. The cart of claim 13, further comprising an upper housing joined to an underside of one of said steps and a lower housing joined to said base beneath said upper housing, said upper and lower housings defining a cavity within which said resilient member is positioned.

15. The cart of claim 14, further comprising a frame that supports said steps, said frame comprising a first end that contacts the surface when said steps are in their first position and a second end that is pivotally coupled with said base.

16. The cart of claim 11, wherein said steps have a width that is approximately equal to a width of said container.

17. A combination cart and ladder that is configured to be transported across a surface, comprising:
a base;
a plurality of wheels coupled with said base for transporting said base across the surface;
a container supported by said base;
a ladder section comprising a frame that is pivotally coupled with said base, and a plurality of steps supported by said frame, said ladder section moveable between a first position in which a portion of said ladder section is in contact with the surface thereby preventing said wheels from transporting said base and an second position in which said wheels are free to transport said base; and
a resilient member coupling said base and a portion of said ladder section spaced a distance from where said ladder section is pivotally coupled with said base, said resilient member biasing said ladder section to its second position.

18. The combination of claim 17, wherein said resilient member comprises a coil spring.

19. The combination of claim 17, wherein said resilient member comprises a tension spring.

20. The combination of claim 17, wherein said plurality of wheels comprises a forward pair of wheels positioned beneath said ladder section, a rearward pair of wheels positioned beneath said container, and a middle pair of wheels positioned between said forward and rearward pairs of wheels.
